(19) United States
(12) Patent Application Publication
(10) Pub. No.: US 2001/0027452 A1
(43) Pub. Date: Oct. 4, 2001

(54) System and method to identify documents in a database which relate to a given document by using recursive searching and no keywords

(76) Inventor: Matthew Bruce Tropper, Plainview, NY (US)

Correspondence Address: Matthew B. Tropper, 30 Southern Parkway, Plainview, NY, 11803, US

(21) Appl. No.: 09/769,906

(22) Filed: Jan. 25, 2001

Related U.S. Application Data
(60) Provisional application No. 60/179,537, filed on Feb. 1, 2000.

(51) Int. Cl. G06F 17/30

(52) U.S. Cl. 707/3; 707/6

(57) ABSTRACT

A system and method to identify documents in a database which relate to a given document by using “recursive” searching and no keywords. More particularly, a system and method to identify documents in a database which relate to a “patent under test” by using “recursive” searching and no keywords. The instant invention may be used as an aid in: 1) designing around a “patent under test” by identifying expired patents dealing with subject matter similar to the subject matter dealt with in the “patent under test”; and 2) determining the validity of the “patent under test” by identifying references which deal with the subject matter dealt with by the “patent under test” and which pre-date the patent under test by a sufficient length of time to be applied as prior art under the applicable laws and regulations.

### CROSS-REFERENCE TO RELATED APPLICATIONS

This application claims the benefit under 35 U.S.C. 119(e) of U.S. Provisional Application Serial Number 60/179,537, filed Feb. 1, 2000.

### BACKGROUND OF THE INVENTION

1. Field of the Invention

The instant invention relates to a system and method to identify documents in a database which relate to a given document by using “recursive” searching and no keywords.

More particularly, the instant invention relates to a system and method to identify documents in a database which relate to a “patent under test” by using “recursive” searching and no keywords.

The instant invention may be used as an aid in: 1) designing around a “patent under test” by identifying expired patents dealing with subject matter similar to the subject matter dealt with in the “patent under test”; and 2) determining the validity of the “patent under test” by identifying references which deal with the subject matter dealt with by the “patent under test” and which pre-date the patent under test by a sufficient length of time to be applied as prior art under the applicable laws and regulations.

As will be discussed in detail below, the instant invention operates by using “recursive” searching and “rule-based” filtering.

2. Description of the Related Art

### Designing Around A Patent

The process of designing around a potentially infringed U.S. patent involves examining the claims of the patent to determine what may be made, used, offered for sale, sold, or imported without infringing the claims of the patent. In deciding what may be made, used, offered for sale, sold, or imported without infringing the claims of the patent one generally looks to the “state of the art” in the field of endeavor to which the patent belongs to find alternative means to perform a desired function. This “state of the art” includes all prior issued patents, both expired and non-expired. For the purposes of designing around a particular patent the prior expired patents are of particular interest, since they provide fertile ground for developing concepts free of infringement of both the claims of the potentially infringed patent as well as the claims of the expired patent.

Referring now to FIG. 1, a prior art search of the database of patents maintained by the U.S. Patent and Trademark Office (“USPTO Patent Database”) aimed at producing search results helpful in designing around a potentially infringed patent will now be described.

The USPTO Patent Database 101 is made available to the public through the U.S. Patent and Trademark Office Internet Website (“USPTO Website”). Searches of the USPTO Patent Database 101 are performed by using a Web Browser 104 (such as Microsoft Corporation's Internet Explorer or Netscape Communications Corporation's Navigator) to enter search criteria into a Database Search Engine 105 associated with the USPTO Website 103 and the USPTO Patent Database 101 and to view the results of the search returned by the Database Search Engine 105. The search criteria are generally chosen to find patents containing particular “keywords” and which were issued or filed at a time far enough into the past to be currently expired. After the search results are returned various “hyperlinks” to other documents within the USPTO Patent Database 101 may be followed individually, by manually selecting them one at a time using Web Browser 104.

While the USPTO Website 103 and associated Database Search Engine 105 are useful, they suffer distinct disadvantages when it comes to finding patents helpful in designing around a potentially infringed patent. More particularly, they only provide for “flat” searching capability wherein a single search is performed using fixed initial search criteria. There is no provision for automatic and adaptive “recursive” searching, that is, searching the database for documents to find a first generation set of documents and then automatically searching the database to find a second generation set of documents based upon data in the documents comprising the first generation set of documents (and so on, for as may “generations” as desired).

Further, the search results are limited to those documents containing the “keywords” used for the search and the search may miss certain documents in the database that are relevant but that do not contain the “keywords”.

Further, there is no provision for automatic and adaptive “recursive” searching based upon a single input, such as the patent number of the “patent under test”.

It is noted that while other organizations (both commercial and governmental) maintain patent databases similar to the USPTO Database, some of which are also accessible via the World Wide Web and some of which are accessible via direct modem connection or other means, it is believed that they likewise suffer from the disadvantages of the USPTO Website discussed above.

### Determining Patent Validity

The validity of a potentially invalid patent depends upon many factors. A major source of patent invalidity is the existence of an earlier document, such as another patent, which renders unpatentable the subject matter claimed in the potentially invalid patent. When arguing that such an earlier document invalidates a potentially invalid patent a party is in a much stronger position if the earlier document was not before the Patent Examiner who examined the application maturing into the potentially invalid patent (such documents that were before the Patent Examiner are identified in a patent under a heading such as References Cited) In other words, there is a presumption that such an earlier document that was before the Patent Examiner does not render unpatentable what is claimed in the potentially invalid patent. In contrast, there is no such presumption attached to earlier documents that were not before the Patent Examiner who examined the application maturing into the potentially invalid patent.

Accordingly, patent validity determinations rely greatly upon searching for earlier documents which may invalidate the potentially invalid patent, particularly earlier documents that were not before the Patent Examiner who examined the application maturing into the potentially invalid patent (and thus not being identified in the References Cited section of the potentially invalid patent). Such earlier documents which can invalidate the potentially invalid patent shall hereafter be referred to as “Invalidating Prior Art”.

Referring again to FIG. 1, a prior art search of the USPTO Patent Database 101 aimed at producing search results helpful in determining the validity of a patent will now be described.

As discussed above, the USPTO Patent Database 101 is made available to the public through the USPTO Website 103. Searches of the USPTO Patent Database 101 are performed by using a Web Browser 104 (such as Microsoft Corporation's Internet Explorer or Netscape Communications Corporation's Navigator) to enter search criteria into a Database Search Engine 105 associated with the USPTO Website 103 and the USPTO Patent Database 101 and to view the results of the search returned by the Database Search Engine 105. The search criteria are generally chosen to find patents containing particular “keywords”. If the search criteria are to include date related criteria designed to aid in finding Invalidating Prior Art then a detailed analysis of the effective filing date and issue date of the “patent under test” must be combined with a thorough knowledge of the applicable laws and regulations to produce effective search criteria in this regard. Since the laws and regulations relating to how early the publication date and/or filing date and/or issue date of a reference must be in order for the reference to be used against the potentially invalid patent as Invalidating Prior Art are complex, the search criteria generally do not take these factors into account. In any case, after the search results are returned various “hyperlinks” to other documents within the USPTO Patent Database 101 may be followed individually, by manually selecting them one at a time using Web Browser 104.

While the USPTO Website 103 and associated Database Search Engine 105 are useful, they suffer distinct disadvantages when it comes to determining the validity of an existing patent. More particularly, they only provide for “flat” searching capability wherein a single search is performed using fixed initial search criteria. There is no provision for automatic and adaptive “recursive” searching, that is, searching the database for documents to find a first generation set of documents and then automatically searching the database to find a second generation set of documents based upon data in the documents comprising the first generation set of documents (and so on, for as may “generations” as desired).

Further, the search results are limited to those documents containing the “keywords” used for the search and the search may miss certain documents in the database that are relevant but that do not contain the “keywords”.

Further, there is no provision for automatic and adaptive “recursive” searching based upon a single input, such as the patent number of the “patent under test”.

Further still, there is no provision for automatically identifying or filtering out from the search results those documents that fail to meet a given predefined “rule” which has a bearing on the relevance of the document to the validity of the “patent under test”.

Finally, it is noted that while other organizations (both commercial and governmental) maintain patent databases similar to the USPTO Database, some of which are also accessible via the World Wide Web and some of which are accessible via direct modem connection or other means, it is believed that they likewise suffer from the disadvantages of the USPTO Website discussed above.

### OBJECTS AND SUMMARY OF THE INVENTION

It is therefore an object of the present invention to provide a system and method to identify documents relating to and pre-dating a “patent under test” (i.e., a potentially infringed patent or a potentially invalid patent).

Another object of the present invention is to provide a system and method which may be used as aids in: 1) designing around a potentially infringed patent by identifying expired patents dealing with subject matter similar to the subject matter dealt with in the potentially infringed patent; and 2) determining the validity of a potentially invalid patent by identifying references which deal with the subject matter dealt with by the potentially invalid patent and which pre-date the potentially invalid patent by a sufficient length of time to be applied as Invalidating Prior Art under the applicable laws and regulations.

It is another object of the present invention to provide a system and method to aid in designing around a potentially infringed patent by examining a database of documents and automatically identifying documents that might aid in designing around the potentially infringed patent. The examination of the database may be carried out after receiving from the user a single search criteria such as the patent number of the potentially infringed patent. The examination of the database can be carried out without relying upon the existence of given “keywords” within a document to identify the document as relevant.

It is another object of the present invention to provide a system and method to aid in designing around a potentially infringed patent by performing an automatic and adaptive “recursive” search of a database, that is, searching the database to find a first generation set of documents and then automatically searching the database to find a second generation set of documents based upon data in the documents comprising the first generation set of documents. Such a “recursive” search may, of course, go on for any desired number of generations.

It is another object of the present invention to automatically apply “rule-based” filtering to the search results in order to identify or filter out those documents not having a bearing (or having less of a bearing) on the process of designing around the potentially infringed patent.

It is another object of the present invention to provide a system and method to aid in the determination of patent validity of a potentially invalid patent by examining a database of documents and automatically identifying documents that might have a bearing on the validity of the potentially invalid patent. The examination of the database may be carried out after receiving from the user a single search criteria such as the patent number of the potentially invalid patent. The examination of the database can be carried out without relying upon the existence of given “keywords” within a document to identify the document as relevant.

It is another object of the present invention to provide a system and method to aid in the determination of patent validity of a potentially invalid patent by performing an automatic and adaptive “recursive” search of a database, that is, searching the database to find a first generation set of documents and then automatically searching the database to find a second generation set of documents based upon data in the documents comprising the first generation set of documents. Such a “recursive” search may, of course, go on for any desired number of generations.

It is another object of the present invention to automatically apply “rule-based” filtering to the search results in order to identify or filter out those documents not having a bearing (or having less of a bearing) on the validity of the potentially invalid patent. The “rule-based” filtering may automatically identify or filter out those documents that were identified in the potentially invalid patent in the References Cited section. The “rule-based” filtering may automatically identify or filter out those documents whose publication date, and/or patent filing date, and/or patent issue date does not proceed the effective patent filing date or patent issue date of the potentially invalid patent by a sufficient length of time for them to be used under the applicable law or regulation as Invalidating Prior Art against the potentially invalid patent.

Other objects and advantages will become apparent from the detailed description, claims, and accompanying drawings.

### BRIEF DESCRIPTION OF THE DRAWINGS

FIG. 1 shows a block diagram of a system for identifying patents in a database according to the prior art;

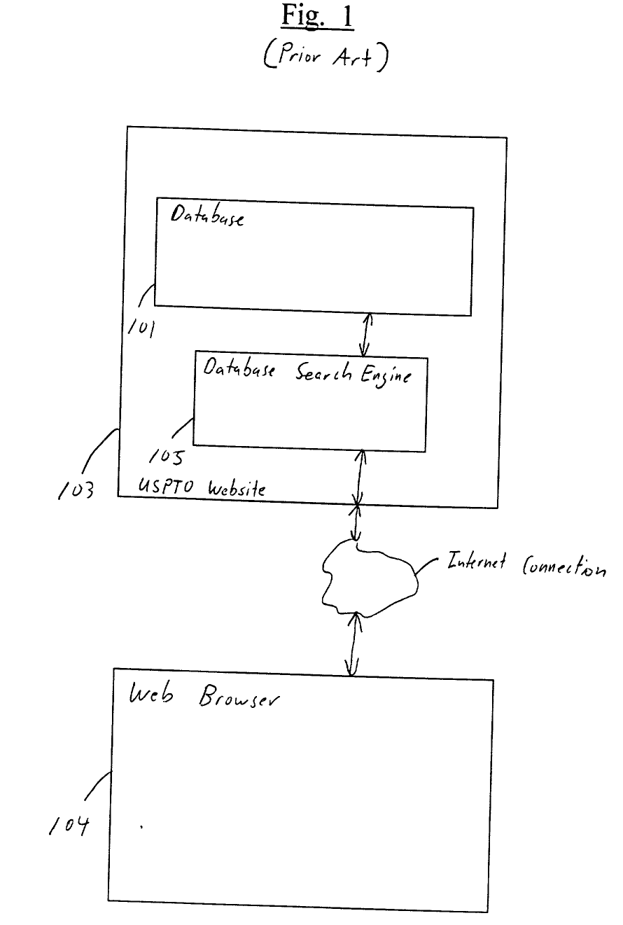

FIG. 2 shows a block diagram of a first embodiment of the instant invention;

FIG. 3 shows the operation of the first embodiment of the instant invention;

FIG. 4 shows a display format corresponding to the first embodiment of the instant invention;

FIG. 5 shows a block diagram of a second embodiment of the instant invention;

FIG. 6 shows the operation of the second embodiment of the instant invention;

FIG. 7 shows a block diagram of a third embodiment of the instant invention;

FIG. 8 shows the operation of the third embodiment of the instant invention;

FIG. 9 shows a block diagram of a fourth embodiment of the instant invention;

FIG. 10 shows the operation of the fourth embodiment of the instant invention;

FIG. 11 shows a block diagram of a fifth embodiment of the instant invention;

FIG. 12 shows the operation of the fifth embodiment of the instant invention;

FIG. 13 shows a block diagram of a sixth embodiment of the instant invention; and

FIG. 14 shows the operation of the sixth embodiment of the instant invention.

### DETAILED DESCRIPTION OF THE PREFERRED EMBODIMENTS

A system for identifying documents in a database which relate to a document under test is provided, comprising: means for retrieving the document under test from the database; means for storing as generation 1 data identifying data corresponding to each reference cited in the document under test; means for retrieving from the database each available reference identified by the identifying data stored as generation 1 data; and means for storing as generation 2 data identifying data corresponding to each reference cited in the references identified by the generation 1 data.

The system may further comprise means for receiving from a user an identification of the document under test. The system may further comprise means for applying rule-based filtering to the stored identifying data. The system may further comprise means for displaying the stored identifying data to the user. The document under test may be a patent under test.

Another system for identifying documents in a database which relate to a document under test is provided, comprising: means for retrieving from the database a list of documents that cite the document under test; means for storing as generation 1 data identifying data corresponding to each document in the list; means for retrieving from the database each available document identified by the identifying data stored as generation 1 data; and means for storing as generation 2 data identifying data corresponding to each reference cited in the documents identified by the generation 1 data.

The system may further comprise means for receiving from a user an identification of the document under test. The system may further comprise means for applying rule-based filtering to the stored identifying data. The system may further comprise means for displaying the stored identifying data to the user. The document under test may be a patent under test.

Another system for identifying documents in a database which relate to a document under test is provided, comprising: means for retrieving from the database a list of documents that cite the document under test; means for storing as generation 1 data identifying data corresponding to each document in the list; means for retrieving from the database a list of documents that cite each document identified by the identifying data stored as generation 1 data; and means for storing as generation 2 data identifying data corresponding to each document in the list of documents that cite each document identified in the generation 1 data.

The system may further comprise means for receiving from a user an identification of the document under test. The system may further comprise means for applying rule-based filtering to the stored identifying data. The system may further comprise means for displaying the stored identifying data to the user. The document under test may be a patent under test.

Another system for identifying documents in a database which relate to a document under test is provided, comprising: document under test retrieval means for retrieving the document under test from the database; generation n data storage means for storing as generation n data identifying data corresponding to each reference cited in the document under test, where n is an integer value; reference k retrieval means for retrieving from the database reference k identified by the generation n data, where k is an integer value; generation n+1 storage means for storing as generation n+1 data identifying data corresponding to each reference cited in reference k; and control means for directing the document under test retrieval means to retrieve the document under test, for directing the generation n data storage means to store as generation n data identifying data corresponding to each reference cited in the document under test, for recursively directing reference k retrieval means to retrieve from the database reference k identified by the generation n data, for recursively directing generation n+1 storage means to store as generation n+1 data identifying data corresponding to each reference cited in reference k, and for setting the values of n and k during the recursive retrieval and storage by reference k retrieval means and generation n+1 storage means, respectively.

The system may further comprise means for receiving from a user an identification of the document under test. The system may further comprise means for applying rule-based filtering to the stored identifying data. The system may further comprise means for displaying the stored identifying data to the user. The document under test may be a patent under test.

Another system for identifying documents in a database which relate to a document under test is provided, comprising: document under test citing documents list retrieval means for retrieving a list of documents citing the document under test from the database; generation n data storage means for storing as generation n data identifying data corresponding to each document in the list of documents citing the document under test, where n is an integer value; document k retrieval means for retrieving from the database document k identified by the generation n data, where k is an integer value; generation n+1 storage means for storing as generation n+1 data identifying data corresponding to each reference cited in document k; and control means for directing the document under test citing documents list retrieval means to retrieve the list of documents citing the document under test, for directing the generation n data storage means to store as generation n data identifying data corresponding to each document in the list of documents citing the document under test, for recursively directing document k retrieval means to retrieve from the database document k identified by the generation n data, for recursively directing generation n+1 storage means to store as generation n+1 data identifying data corresponding to each reference cited in document k, and for setting the values of n and k during the recursive retrieval and storage by document k retrieval means and generation n+1 storage means, respectively.

The system may further comprise means for receiving from a user an identification of the document under test. The system may further comprise means for applying rule-based filtering to the stored identifying data. The system may further comprise means for displaying the stored identifying data to the user. The document under test may be a patent under test.

Another system for identifying documents in a database which relate to a document under test is provided, comprising: document under test citing documents list retrieval means for retrieving a list of documents citing the document under test from the database; generation n data storage means for storing as generation n data identifying data corresponding to each document in the list of documents citing the document under test, where n is an integer value; citing documents list k retrieval means for retrieving from the database a list of documents citing each document identified by the generation n data, where k is an integer value; generation n+1 storage means for storing as generation n+1 data identifying data corresponding to each document in the list of documents citing each document identified by the generation n data; and control means for directing the document under test citing documents list retrieval means to retrieve the list of documents citing the document under test, for directing the generation n data storage means to store as generation n data identifying data corresponding to each document in the list of documents citing the document under test, for recursively directing citing documents list k retrieval means to retrieve from the database a list of documents citing each document identified by the generation n data, for recursively directing generation n+1 storage means to store as generation n+1 data identifying data corresponding to each document in the list of documents citing each document identified by the generation n data, and for setting the values of n and k during the recursive retrieval and storage by citing documents list k retrieval means and generation n+1 storage means, respectively.

The system may further comprise means for receiving from a user an identification of the document under test. The system may further comprise means for applying rule-based filtering to the stored identifying data. The system may further comprise means for displaying the stored identifying data to the user. The document under test may be a patent under test.

A method for identifying documents in a database which relate to a document under test is provided, comprising the steps of: a) retrieving the document under test from the database; b) storing as generation 1 data identifying data corresponding to each reference cited in the document under test; c) retrieving from the database each available reference identified by the identifying data stored as generation 1 data; and d) storing as generation 2 data identifying data corresponding to each reference cited in the references identified by the generation 1 data.

The method may further comprise the step of receiving from a user an identification of the document under test. The method may further comprise the step of applying rule-based filtering to the stored identifying data. The method may further comprise the step of displaying the stored identifying data to the user. The document under test may be a patent under test.

Another method for identifying documents in a database which relate to a document under test is provided, comprising the steps of: a) retrieving a list of documents that cite the document under test from the database; b) storing as generation 1 data identifying data corresponding to each reference in the list; c) retrieving from the database each available reference identified by the identifying data stored as generation 1 data; and d) storing as generation 2 data identifying data corresponding to each reference cited in the references identified by the generation 1 data.

The method may further comprise the step of receiving from a user an identification of the document under test. The method may further comprise the step of applying rule-based filtering to the stored identifying data. The method may further comprise the step of displaying the stored identifying data to the user. The document under test may be a patent under test.

Another method for identifying documents in a database which relate to a document under test is provided, comprising the steps of: a) retrieving from the database a list of documents that cite the document under test; b) storing as generation 1 data identifying data corresponding to each document in the list; c) retrieving from the database a list of documents that cite each document identified by the identifying data stored as generation 1 data; and d) storing as generation 2 data identifying data corresponding to each document in the list of documents that cite each document identified in the generation 1 data.

The method may further comprise the step of receiving from a user an identification of the document under test. The method may further comprise the step of applying rule-based filtering to the stored identifying data. The method may further comprise the step of displaying the stored identifying data to the user. The document under test may be a patent under test.

A method for identifying documents in a database which relate to a document under test is provided, comprising the steps of: a) retrieving the document under test from the database; b) storing as generation n data identifying data corresponding to each reference cited in the document under test, where n is an integer initially equal to 1; c) retrieving from the database reference k identified by the generation n data, where k is an integer initially equal to 1; d) storing as generation n+1 data identifying data corresponding to each reference cited in reference k; e) incrementing the value of k upward by 1 and repeating steps c and d until all of the available references identified in the generation n data are retrieved; and f) incrementing the value of n upward by 1, resetting the value of k to 1, and repeating the process beginning at step c for a desired number of generations.

The method may further comprise the step of receiving from a user an identification of the document under test. The method may further comprise the step of applying rule-based filtering to the stored identifying data. The method may further comprise the step of displaying the stored identifying data to the user. The document under test may be a patent under test.

Another method for identifying documents in a database which relate to a document under test is provided, comprising the steps of: a) retrieving from the database a list of documents that cite the document under test; b) storing as generation n data identifying data corresponding to each document in the list, where n is an integer initially equal to 1; c) retrieving from the database document k identified by the generation n data, where k is an integer initially equal to 1; d) storing as generation n+1 data identifying data corresponding to each reference cited in document k; e) incrementing the value of k upward by 1 and repeating steps c and d until all of the available documents identified in the generation n data are retrieved; and f) incrementing the value of n upward by 1, resetting the value of k to 1, and repeating the process beginning at step c for a desired number of generations. The method may further comprise the step of receiving from a user an identification of the document under test. The method may further comprise the step of applying rule-based filtering to the stored identifying data. The method may further comprise the step of displaying the stored identifying data to the user. The document under test may be a patent under test.

Another method for identifying documents in a database which relate to a document under test is provided, comprising the steps of: a) retrieving from the database a list of documents that cite the document under test; b) storing as generation n data identifying data corresponding to each document in the list, where n is an integer initially equal to 1; c) retrieving from the database a list of documents that cite document k identified by the generation n data, where k is an integer initially equal to 1; d) storing as generation n+1 data identifying data corresponding to each document in the list; e) incrementing the value of k upward by 1 and repeating steps c and d until all of the available documents identified in the generation n data are retrieved; and f) incrementing the value of n upward by 1, resetting the value of k to 1, and repeating the process beginning at step c for a desired number of generations.

The method may further comprise the step of receiving from a user an identification of the document under test. The method may further comprise the step of applying rule-based filtering to the stored identifying data. The method may further comprise the step of displaying the stored identifying data to the user. The document under test may be a patent under test.

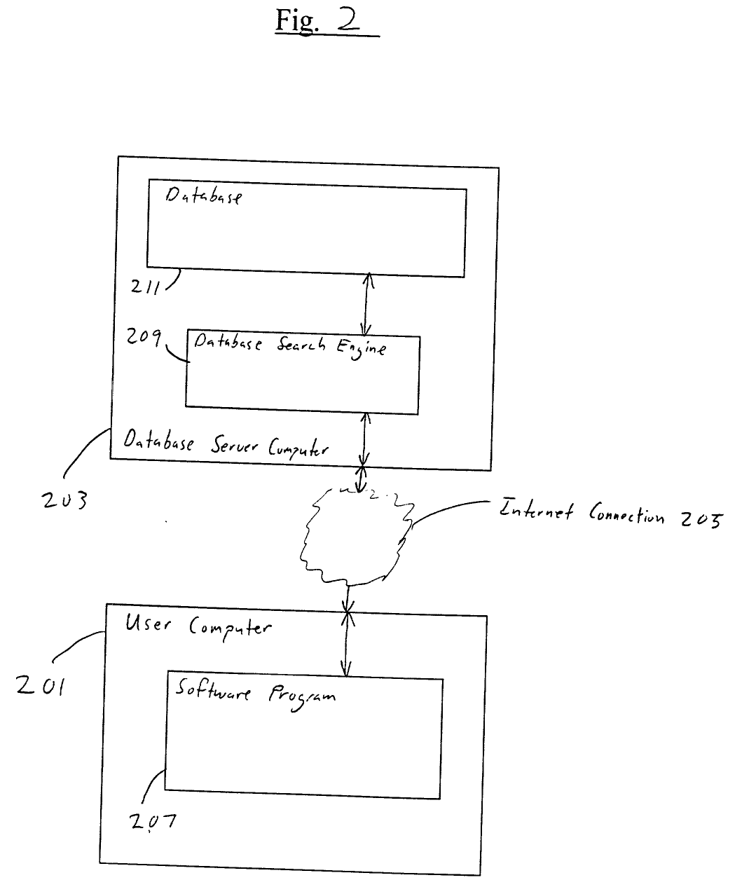

Referring now to FIG. 2, a first embodiment of the instant invention is shown. This embodiment relates to searching for references contained within the USPTO Patent Database via the Internet. As seen in this FIG., User Computer 201 (which is shown in block diagram form and which includes a CPU, a monitor, a keyboard, and a mouse, all of which are not shown) is connected to a Database Server Computer 203 (also shown in block diagram form) through an Internet Connection 205. The Database Server Computer 203 is maintained by the USPTO as part of its Website. The interconnection of two computers via the Internet is well known to those of ordinary skill in the art and shall not be discussed further.

In any case, User Computer 201 has installed thereon Software Program 207. Software Program 207 may be installed on User Computer 201 using any suitable procedure such as CD distribution or electronic distribution, for example. Such suitable installation procedures are well known to those of ordinary skill in the art and shall not be discussed further. Database Server Computer 203 has installed thereon Database Search Engine 209. Database Server Computer 203 also has access to Database 211, which may be installed on Database Server Computer 203 (as seen in this FIG.) or which may be located on another computer (not shown) to which Database Server Computer 203 has access.

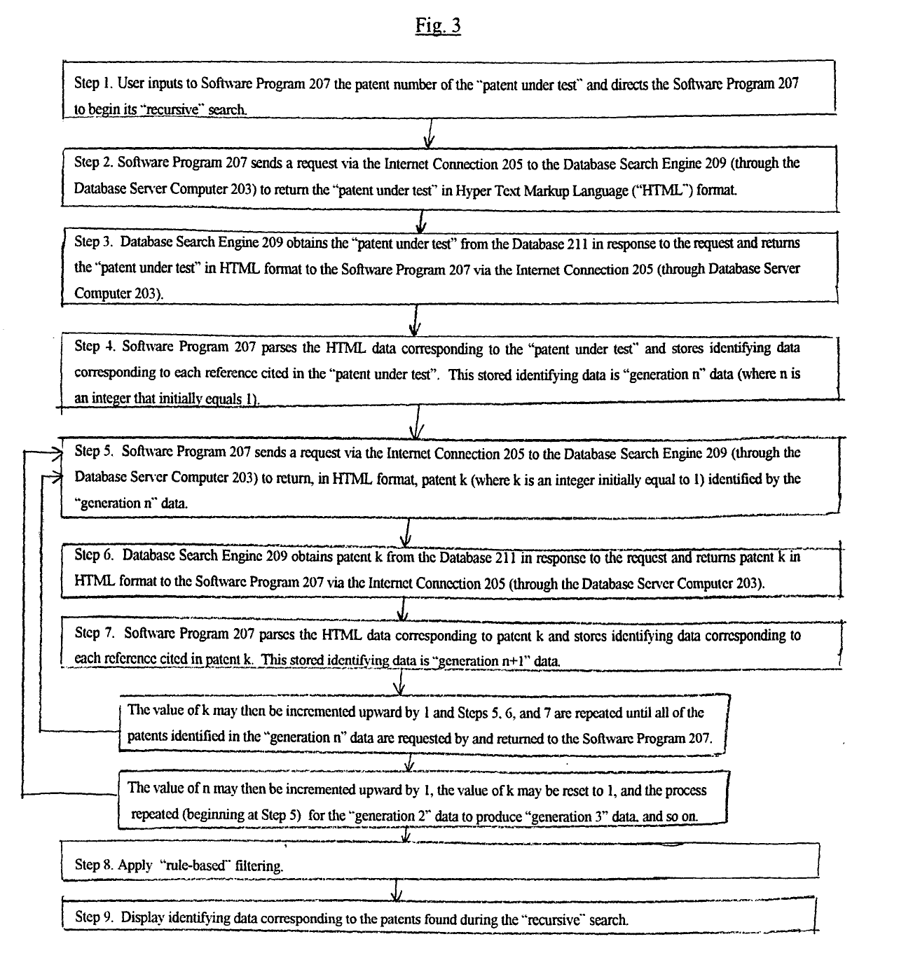

The interaction of Software Program 207 with Database Search Engine 209 and Database 211 will now be described in more detail with reference to FIG. 3.

As seen in FIG. 3, at Step 1 a user inputs to Software Program 207 the patent number of the “patent under test” (which may be a potentially infringed patent or a potentially invalid patent, for example) and directs the Software Program 207 to begin its “recursive” search. At Step 2 the Software Program 207 sends a request via the Internet Connection 205 to the Database Search Engine 209 (through the Database Server Computer 203) to return the “patent under test” in Hyper Text Markup Language (“HTML”) format. The request, as well as all subsequent communications between the User Computer 201 and the Database Server Computer 203 may be carried out using the Hyper Text Transfer Protocol (“HTTP”). At Step 3 the Database Search Engine 209 obtains the “patent under test” from the Database 211 in response to the request and returns the “patent under test” in HTML format to the Software Program 207 via the Internet Connection 205 (through Database Server Computer 203). At Step 4 the Software Program 207 parses the HTML data corresponding to the “patent under test” and stores identifying data corresponding to each reference cited in the “patent under test”. The stored identifying data may include the patent number, the issue date, the inventor name, and the class/subclass of each reference. This stored identifying data is “generation n” data (where n is an integer that initially equals 1). At Step 5 the Software Program 207 sends a request via the Internet Connection 205 to the Database Search Engine 209 (through the Database Server Computer 203) to return, in HTML format, patent k (where k is an integer that initially equals 1) identified by the “generation n” data. At Step 6 the Database Search Engine 209 obtains patent k from the Database 211 in response to the request and returns patent k in HTML format to the Software Program 207 via the Internet Connection 205 (through the Database Server Computer 203). At Step 7 the Software Program 207 parses the HTML data corresponding to patent k and stores identifying data corresponding to each reference cited in patent k. The stored identifying data may include the patent number, the issue date, the inventor name, and the class/subclass of each reference. This stored identifying data is “generation n+1” data (i.e., if n is currently equal to 1 then this is “generation 2” data, if n is currently equal to 2 then this is “generation 3” data, and so on). The value of k may then be incremented upward by 1 and Steps 5, 6, and 7 are repeated until all of the patents identified in the “generation n” data are requested by and returned to the Software Program 207. The value of n may then be incremented upward by 1, the value of k reset to 1, and the process repeated (beginning at Step 5) for the “generation 2” data to produce “generation 3” data, and so on.

The user may indicate to Software Program 207 to search for a given number of generations of data, or the user may indicate to Software Program 207 to search for a given length of time, or the user may indicate to Software Program 207 to search until a given number of references have been stored, or the user may allow the Software Program 207 to search until commanded to stop by the user.

In any case, after the Software Program 207 finishes the “recursive” search it may employ “rule-based” filtering at Step 8 to narrow the search results. The “rule-based” filtering may be applied by marking as less relevant or non-relevant those patents that do not meet the “rules” applied by the “rule-based” filtering. The marking may be carried out by storing, along with the identifying data, an indication of which “rule” has not been met, why it has not been met, and the degree of relevance with regard to the “patent under test”.

One such “rule” that is preferably utilized when the “patent under test” is a potentially invalid patent is that each of the patents found during the “recursive” search must not have been identified in the References Cited section of the “patent under test”. Failure to meet this test would preferably cause a patent to be marked as less relevant. Another such “rule” that is preferably utilized when the “patent under test” is a potentially invalid patent is that each of the patents found during the “recursive” search must have a filing date and/or issue date earlier enough to be applied as prior art against the “patent under test” pursuant to Sections 102 and 103 of Title 35 of the United States Code (“35 USC 102” and 35 USC 103”, respectively, the text of each of which is incorporated herein by reference). Failure to meet this test would preferably cause the patent to be marked as non-relevant.

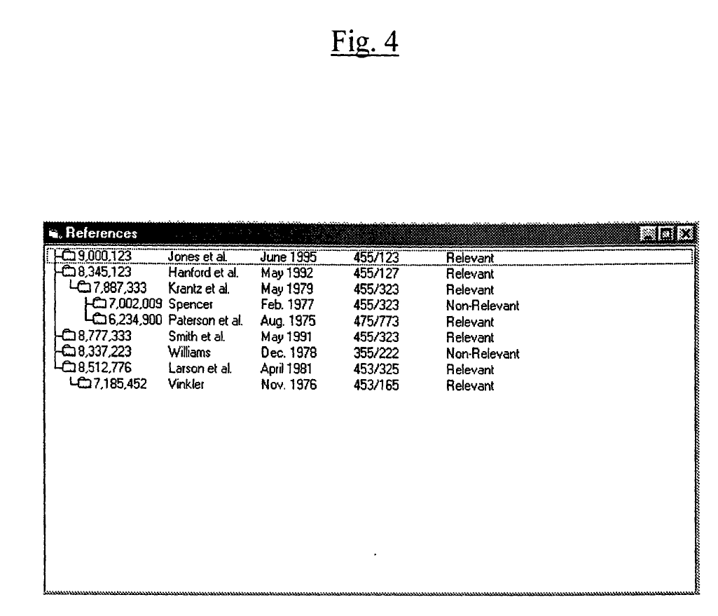

After the “rule-based” filtering is applied the identifying data corresponding to the patents found during the “recursive” search may be displayed to the user at Step 9. The display may be in the form of a simple list of each of the patent numbers (along with patent date, and/or inventor name, and/or class/subclass, and or indication of “rule-based” filtering status, as desired by the user). More preferably, the display may be in the form of a hierarchical list of each of the patent numbers (along with patent date, and/or inventor name, and/or class/subclass, and or indication of “rule-based” filtering status, as desired by the user). As seen in FIG. 4, the hierarchical list preferably shows all “generation 1” data at a topmost indentation level, then all “generation 2” data at a lower indentation level, and so on for each subsequent “generation” of data. In addition, the hierarchical list is preferably structured such that the data in each “generation” is displayed via a “parent-child” relationship with the patent from the prior “generation” that referenced it. The Software Program 207 may also provide the user the option of printing out and/or storing the aforementioned list.

Turning now to a more detailed discussion of Software Program 207, the parsing operations of FIG. 3 will now be discussed. As described above, the parsing operations are performed on HTML data corresponding to the patent returned by the Database Server Computer 203. The HTML data includes HTML “Tags” as well as standard text strings corresponding to section headings, such as “Abstract” and “References Cited”. These HTML “Tags” and standard text strings are substantially the same from one patent to the next. Accordingly, Software Program 207 can identify necessary data corresponding to a patent identified in the References Cited section of a patent returned by the Database Server Computer 203 (such as patent number, issue date, inventor name, and class/subclass) by searching for the HTML “Tags” and/or standard text strings that surround such necessary data.

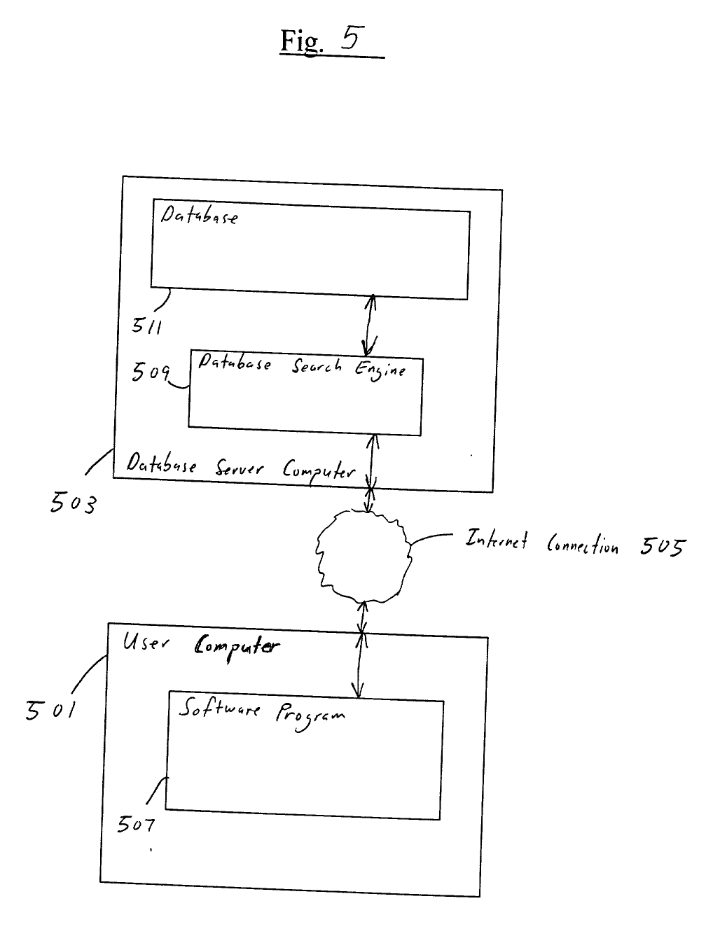

Referring now to FIG. 5, a second embodiment of the instant invention is shown. This embodiment, like the first embodiment, relates to searching for references contained within the USPTO Patent Database via the Internet. The main difference between these two embodiments is that the first embodiment performs a “recursive” search initially based upon the references cited in the “patent under test” while the second embodiment performs a “recursive” search initially based upon the references citing the “patent under test”. In any case, as seen in this FIG. 5, User Computer 501 (which is shown in block diagram form and which includes a CPU, a monitor, a keyboard, and a mouse, all of which are not shown) is connected to a Database Server Computer 503 (also shown in block diagram form) through an Internet Connection 505. The Database Server Computer 503 is maintained by the USPTO as part of its Website. The interconnection of two computers via the Internet is well known to those of ordinary skill in the art and shall not be discussed further.

User Computer 501 has installed thereon Software Program 507. Software Program 507 may be installed on User Computer 501 using any suitable procedure such as CD distribution or electronic distribution, for example. Such suitable installation procedures are well known to those of ordinary skill in the art and shall not be discussed further. Database Server Computer 503 has installed thereon Database Search Engine 509. Database Server Computer 503 also has access to Database 511, which may be installed on Database Server Computer 503 (as seen in this FIG.) or which may be located on another computer (not shown) to which Database Server Computer 503 has access.

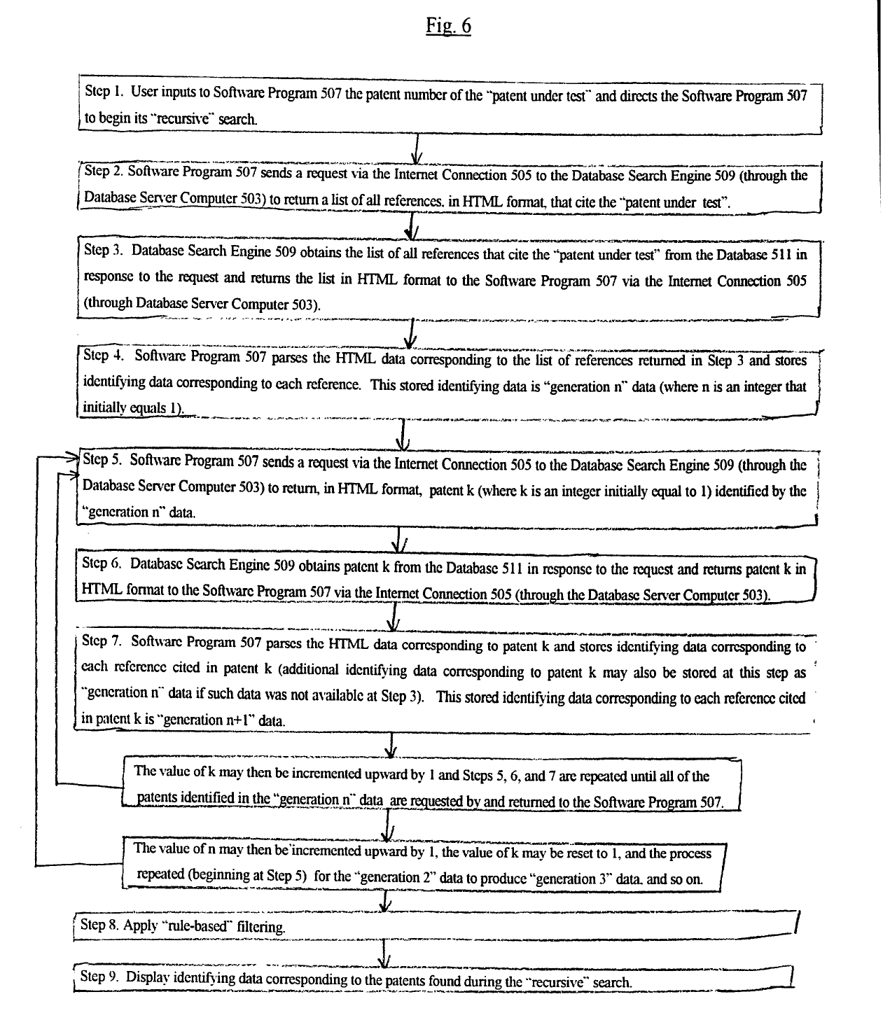

The interaction of Software Program 507 with Database Search Engine 509 and Database 511 will now be described in more detail with reference to FIG. 6.

As seen in FIG. 6, at Step 1 a user inputs to Software Program 507 the patent number of the “patent under test” (which may be a potentially infringed patent or a potentially invalid patent, for example) and directs the Software Program 507 to begin its “recursive” search. At Step 2 the Software Program 507 sends a request via the Internet Connection 505 to the Database Search Engine 509 (through the Database Server Computer 503) to return a list of all references, in HTML format, that cite the “patent under test”. The request, as well as all subsequent communications between the User Computer 501 and the Database Server Computer 503 may be carried out using the Hyper Text Transfer Protocol (“HTTP”). At Step 3 the Database Search Engine 509 obtains the list of all references that cite the “patent under test” from the Database 511 in response to the request and returns the list in HTML format to the Software Program 507 via the Internet Connection 505 (through Database Server Computer 503). At Step 4 the Software Program 507 parses the HTML data corresponding to the list of references returned in Step 3 and stores identifying data corresponding to each reference. The stored identifying data may include the patent number, the issue date, the inventor name, and the class/subclass of each reference. This stored identifying data is “generation n” data (where n is an integer that initially equals 1). At Step 5 the Software Program 507 sends a request via the Internet Connection 505 to the Database Search Engine 509 (through the Database Server Computer 503) to return, in HTML format, patent k (where k is an integer initially equal to 1) identified by the “generation n” data. At Step 6 the Database Search Engine 509 obtains patent k from the Database 511 in response to the request and returns patent k in HTML format to the Software Program 507 via the Internet Connection 505 (through the Database Server Computer 503). At Step 7 the Software Program 507 parses the HTML data corresponding to patent k and stores identifying data corresponding to each reference cited in patent k (additional identifying data corresponding to patent k may also be stored at this step as “generation n” data if such data was not available at Step 3). The stored identifying data may include the patent number, the issue date, the inventor name, and the class/subclass of each reference. This stored identifying data corresponding to each reference cited in patent k is “generation n+1” data (i.e., if n is currently equal to 1 then this is “generation 2” data, if n is currently equal to 2 then this is “generation 3” data, and so on) . The value of k may then be incremented upward by 1 and Steps 5, 6, and 7 are repeated until all of the patents identified in the “generation n” data are requested by and returned to the Software Program 507. The value of n may then be incremented upward by 1, the value of k may be reset to 1, and the process repeated (beginning at Step 5) for the “generation 2” data to produce “generation 3” data, and so on.

The user may indicate to Software Program 507 to search for a given number of generations of data, or the user may indicate to Software Program 507 to search for a given length of time, or the user may indicate to Software Program 507 to search until a given number of references have been stored, or the user may allow the Software Program 507 to search until commanded to stop by the user.

In any case, after the Software Program 507 finishes the “recursive” search it may employ “rule-based” filtering (Step 8 of FIG. 6) to narrow the search results. The “rule-based” filtering may be in the form described with reference to the first embodiment of the instant invention.

After the “rule-based” filtering is applied the identifying data corresponding to the patents found during the “recursive” search may be displayed to the user (Step 9 of FIG. 6). The display may be in the form described with reference to the first embodiment of the instant invention. The Software Program 507 may also provide the user the option of printing out and/or storing the search results.

Regarding the parsing operations of FIG. 6, it is noted that these operations may be carried out in a manner similar to that described with reference to the first embodiment of the instant invention (i.e., by searching for the HTML “Tags” and standard text strings that are substantially the same from one patent to the next.

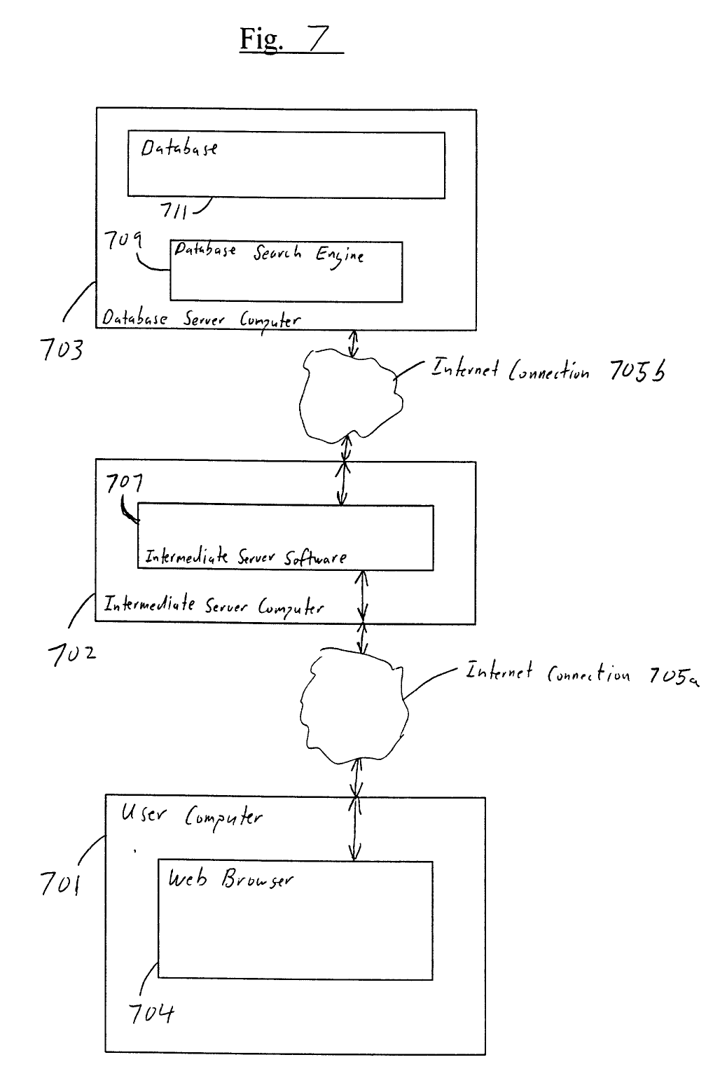

Referring now to FIG. 7, a third embodiment of the instant invention is shown. Like the first and second embodiments this embodiment also relates to searching for references contained within the USPTO Patent Database via the Internet. The main difference is that this third embodiment utilizes an intermediate server computer. As seen in this FIG. 7, User Computer 701 (which is shown in block diagram form and which includes a CPU, a monitor, a keyboard, and a mouse, all of which are not shown) is connected to an Intermediate Server Computer 702 (also shown in block diagram form) through an Internet Connection 705a. Intermediate Server Computer 702 is connected to Database Server Computer 703 (also shown in block diagram form) through an Internet Connection 705b. The Database Computer 703 is maintained by the USPTO as part of its Website. The interconnection of computers via the Internet is well known to those of ordinary skill in the art and shall not be discussed further.

In any case, User Computer 701 has installed thereon a Web Browser 704 (such as Microsoft Corporation's Internet Explorer or Netscape Communications Corporation's Navigator). Intermediate Server Computer 702 has installed thereon Intermediate Server Software 707. Intermediate Server Software 707 is capable of communicating with User Computer 701 via Internet Connection 705a (using the HTTP protocol, for example) as well as communicating with Database Server Computer 703 via Internet Connection 705b (using the HTTP protocol, for example. As discussed in more detail below, Intermediate Server Software 707 also provides means for receiving input from Web Browser 704, means for requesting and receiving data from Database Server Computer 703, and means for providing data to Web Browser 704. These functions may be accomplished using any suitable technology, such as HTML, Extended HTML, Dynamic HTML, Active Server Pages, ActiveX Components, Java, or JavaScript, for example. All of the aforementioned technologies are well known to one of ordinary skill in the art and shall not be discussed further. Database Server Computer 703 has installed thereon Database Search Engine 709. Database Server Computer 703 also has access to Database 711, which may be installed on Database Server Computer 703 (as seen in this FIG.) or which may be located on another computer (not shown) to which Database Server Computer 703 has access.

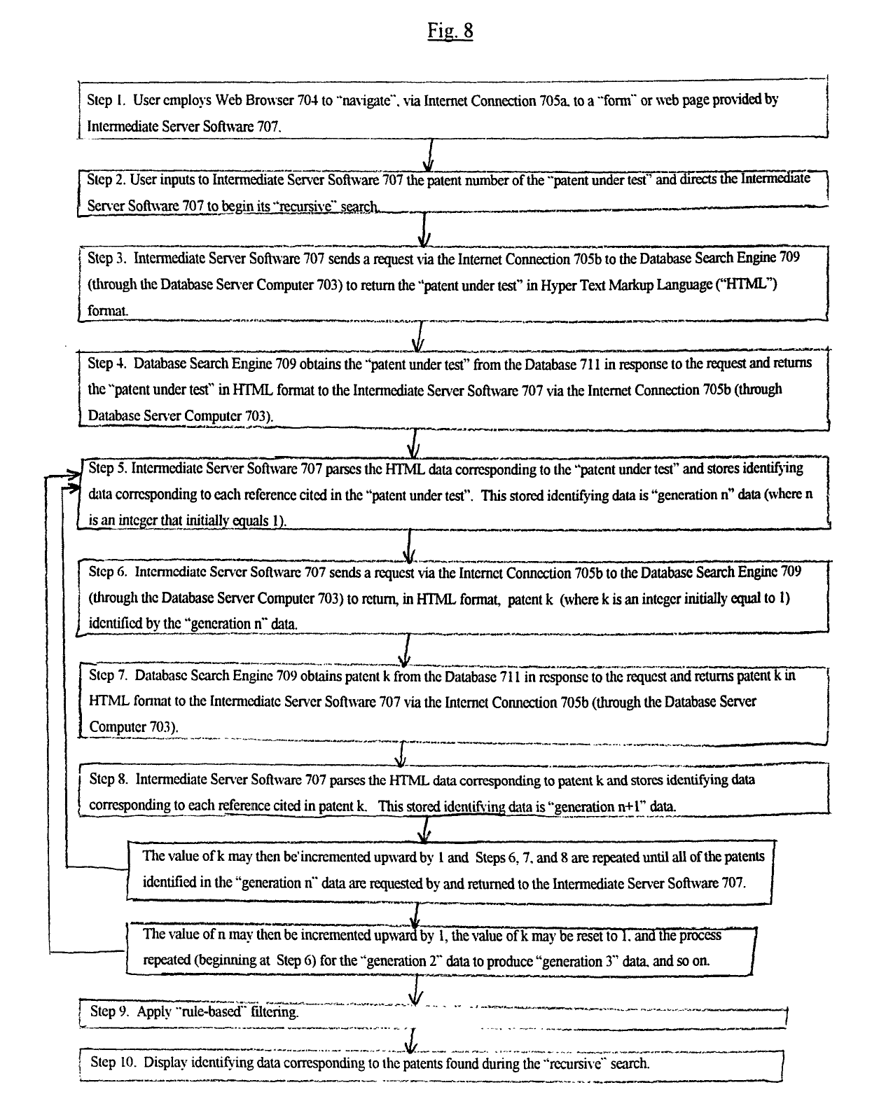

The interaction of Intermediate Server Software 707 with Database Search Engine 709 and Database 711 will now be described in more detail with reference to FIG. 8.

As seen in FIG. 8, at Step 1 a user employs Web Browser 704 to “navigate”, via Internet Connection 705a, to a “form” or web page provided by Intermediate Server Software 707. At Step 2 the user inputs to Intermediate Server Software 707 the patent number of the “patent under test” (which may be a potentially infringed patent or a potentially invalid patent, for example) and directs the Intermediate Server Software 707 to begin its “recursive” search. At Step 3 the Intermediate Server Software 707 sends a request via the Internet Connection 705b to the Database Search Engine 709 (through the Database Server Computer 703) to return the “patent under test” in Hyper Text Markup Language (“HTML”) format. The request, as well as all subsequent communications between the Intermediate Server Computer 702 and the Database Server Computer 703 may be carried out using the Hyper Text Transfer Protocol (“HTTP”). At Step 4 the Database Search Engine 709 obtains the “patent under test” from the Database 711 in response to the request and returns the “patent under test” in HTML format to the Intermediate Server Software 707 via the Internet Connection 705b (through Database Server Computer 703). At Step 5 the Intermediate Server Software 707 parses the HTML data corresponding to the “patent under test” and stores identifying data corresponding to each reference cited in the “patent under test”. The stored identifying data may include the patent number, the issue date, the inventor name, and the class/subclass of each reference. This stored identifying data is “generation n” data (where n is an integer that initially equals 1). At Step 6 the Intermediate Server Software 707 sends a request via the Internet Connection 705b to the Database Search Engine 709 (through the Database Server Computer 703) to return, in HTML format, patent k (where k is an integer initially equal to 1) identified by the “generation n” data. At Step 7 the Database Search Engine 709 obtains patent k from the Database 711 in response to the request and returns patent k in HTML format to the Intermediate Server Software 707 via the Internet Connection 705b (through the Database Server Computer 703). At Step 8 the Intermediate Server Software 707 parses the HTML data corresponding to patent k and stores identifying data corresponding to each reference cited in patent k. The stored identifying data may include the patent number, the issue date, the inventor name, and the class/subclass of each reference. This stored identifying data is “generation n+1” data (i.e., if n is currently equal to 1 then this is “generation 2” data, if n is currently equal to 2 then this is “generation 3” data, and so on) The value of k may then be incremented upward by 1 and Steps 6, 7, and 8 are repeated until all of the patents identified in the “generation n” data are requested by and returned to the Intermediate Server Software 707. The value of n may then be incremented upward by 1, the value of k may be reset to 1, and the process repeated (beginning at Step 6) for the “generation 2” data to produce “generation 3” data, and so on.

The user may indicate to Intermediate Server Software 707 (via Web Browser 704) to search for a given number of generations of data, or the user may indicate to Intermediate Server Software 707 to search for a given length of time, or the user may indicate to Intermediate Server Software 707 to search until a given number of references have been stored, or the user may allow the Intermediate Server Software 707 to search until commanded to stop by the user.

In any case, after the Intermediate Server Software 707 finishes the “recursive” search it may employ “rule-based” filtering (Step 9 of FIG. 8) to narrow the search results. The “rule-based” filtering may be in the form described with reference to the first embodiment of the instant invention.

After the “rule-based” filtering is applied the identifying data corresponding to the patents found during the “recursive” search may be displayed to the user on Web Browser 704 (Step 10 of FIG. 8) via a “form” or web page provided by Intermediate Server Software 707 through Internet Connection 705a. The display may be in the form described with reference to the first embodiment of the instant invention. The Intermediate Server Software 707 may also provide the user the option of printing out and/or storing the search results.

Regarding the parsing operations of FIG. 8, it is noted that these operations may be carried out in a manner similar to that described with reference to the first embodiment of the instant invention (i.e., by searching for the HTML “Tags” and standard text strings that are substantially the same from one patent to the next.

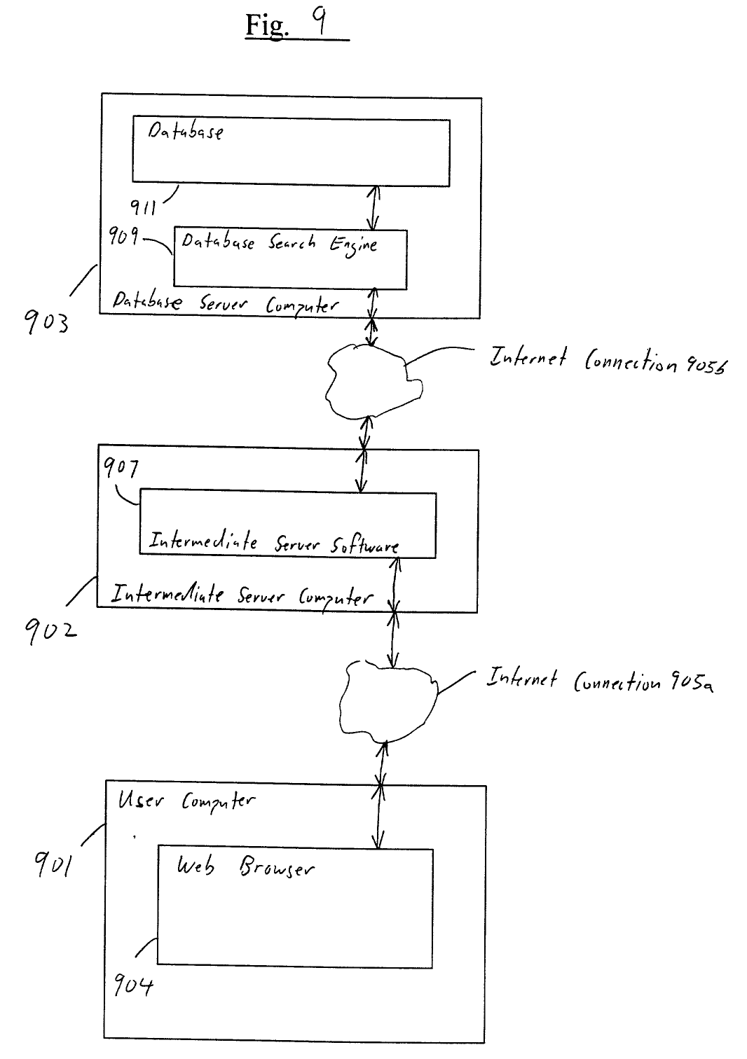

Referring now to FIG. 9, a fourth embodiment of the instant invention is shown. This embodiment, like the third embodiment, relates to searching for references contained within the USPTO Patent Database via the Internet by using an intermediate server computer. The main difference between these two embodiments is that the third embodiment performs a “recursive” search initially based upon the references cited in the “patent under test” while the fourth embodiment performs a “recursive” search initially based upon the references citing the “patent under test. As seen in this FIG. 9, User Computer 901 (which is shown in block diagram form and which includes a CPU, a monitor, a keyboard, and a mouse, all of which are not shown) is connected to an Intermediate Server Computer 902 (also shown in block diagram form) through an Internet Connection 905a. Intermediate Server Computer 902 is connected to Database Server Computer 903 (also shown in block diagram form) through an Internet Connection 905b. The Database Server Computer 903 is maintained by the USPTO as part of its Website. The interconnection of computers via the Internet is well known to those of ordinary skill in the art and shall not be discussed further.

In any case, User Computer 901 has installed thereon a Web Browser 904 (such as Microsoft Corporation's Internet Explorer or Netscape Communications Corporation's Navigator). Intermediate Server Computer 902 has installed thereon Intermediate Server Software 907. Intermediate Server Software 907 is capable of communicating with User Computer 901 via Internet Connection 905a (using the HTTP protocol, for example) as well as communicating with Database Server Computer 903 via Internet Connection 905b (using the HTTP protocol, for example. As discussed in more detail below, Intermediate Server Software 907 also provides means for receiving input from Web Browser 904, means for requesting and receiving data from Database Server Computer 903, and means for providing data to Web Browser 904. These functions may be accomplished using any suitable technology, such as HTML, Extended HTML, Dynamic HTML, Active Server Pages, ActiveX Components, Java, or JavaScript, for example. All of the aforementioned technologies are well known to one of ordinary skill in the art and shall not be discussed further. Database Server Computer 903 has installed thereon Database Search Engine 909. Database Server Computer 903 also has access to Database 911, which may be installed on Database Server Computer 903 (as seen in this FIG.) or which may be located on another computer (not shown) to which Database Server Computer 903 has access.

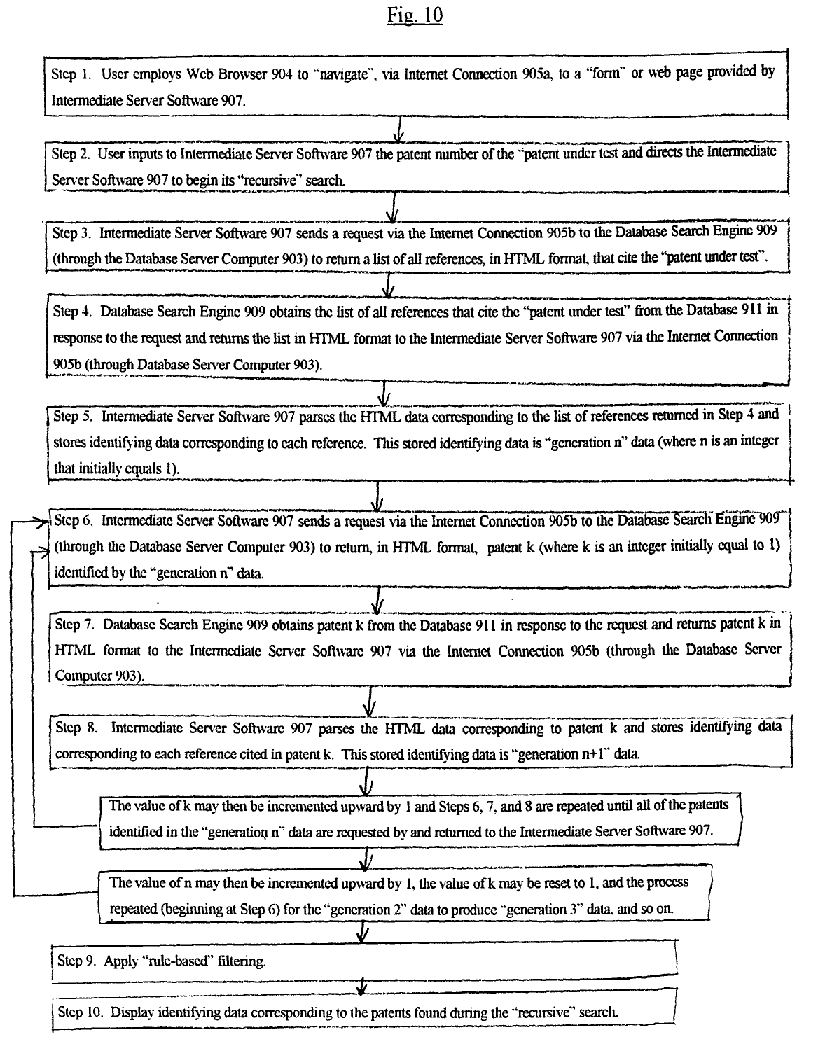

The interaction of Intermediate Server Software 907 with Database Search Engine 909 and Database 911 will now be described in more detail with reference to FIG. 10.

As seen in FIG. 10, at Step 1 a user employs Web Browser 904 to “navigate”, via Internet Connection 905a, to a “form” or web page provided by Intermediate Server Software 907. At Step 2 the user inputs to Intermediate Server Software 907 the patent number of the “patent under test” (which may be a potentially infringed patent or a potentially invalid patent, for example) and directs the Intermediate Server Software 907 to begin its “recursive” search. At Step 3 the Intermediate Server Software 907 sends a request via the Internet Connection 905b to the Database Search Engine 909 (through the Database Server Computer 903) to return a list of all references, in HTML format, that cite the “patent under test”. The request, as well as all subsequent communications between the Intermediate Server Computer 901 and the Database Server Computer 903 may be carried out using the Hyper Text Transfer Protocol (“HTTP”). At Step 4 the Database Search Engine 909 obtains the list of all references that cite the “patent under test” from the Database 911 in response to the request and returns the list in HTML format to the Intermediate Server Software 907 via the Internet Connection 905b (through Database Server Computer 903). At Step 5 the Intermediate Server Software 907 parses the HTML data corresponding to the list of references returned in Step 4 and stores identifying data corresponding to each reference. The stored identifying data may include the patent number, the issue date, the inventor name, and the class/subclass of each reference. This stored identifying data is “generation n” data (where n is an integer that initially equals 1). At Step 6 the Intermediate Server Software 907 sends a request via the Internet Connection 905b to the Database Search Engine 909 (through the Database Server Computer 903) to return, in HTML format, patent k (where k is an integer initially equal to 1) identified by the “generation n” data. At Step 7 the Database Search Engine 909 obtains patent k from the Database 911 in response to the request and returns patent k in HTML format to the Intermediate Server Software 907 via the Internet Connection 905b (through the Database Server Computer 903). At Step 8 the Intermediate Server Software 907 parses the HTML data corresponding to patent k and stores identifying data corresponding to each reference cited in patent k. The stored identifying data may include the patent number, the issue date, the inventor name, and the class/subclass of each reference. This stored identifying data is “generation n+1” data (i.e., if n is currently equal to 1 then this is “generation 2” data, if n is currently equal to 2 then this is “generation 3” data, and so on). The value of k may then be incremented upward by 1 and Steps 6, 7, and 8 are repeated until all of the patents identified in the “generation n” data are requested by and returned to the Intermediate Server Software 907. The value of n may then be incremented upward by 1, the value of k may be reset to 1, and the process repeated (beginning at Step 6) for the “generation 2” data to produce “generation 3” data, and so on.

The user may indicate to Intermediate Server Software 907 (via Web Browser 904) to search for a given number of generations of data, or the user may indicate to Intermediate Server Software 907 to search for a given length of time, or the user may indicate to Intermediate Server Software 907 to search until a given number of references have been stored, or the user may allow the Intermediate Server Software 907 to search until commanded to stop by the user.

In any case, after the Intermediate Server Software 907 finishes the “recursive” search it may employ “rule-based” filtering (Step 9 of FIG. 10) to narrow the search results. The “rule-based” filtering may be in the form described with reference to the first embodiment of the instant invention.

After the “rule-based” filtering is applied the identifying data corresponding to the patents found during the “recursive” search may be displayed to the user on Web Browser 904 (Step 10 of FIG. 10) via a “form” or web page provided by Intermediate Server Software 907 through Internet Connection 905a. The display may be in the form described with reference to the first embodiment of the instant invention. The Intermediate Server Software 907 may also provide the user the option of printing out and/or storing the search results.

Regarding the parsing operations of FIG. 10, it is noted that these operations may be carried out in a manner similar to that described with reference to the first embodiment of the instant invention (i.e., by searching for the HTML “Tags” and standard text strings that are substantially the same from one patent to the next.

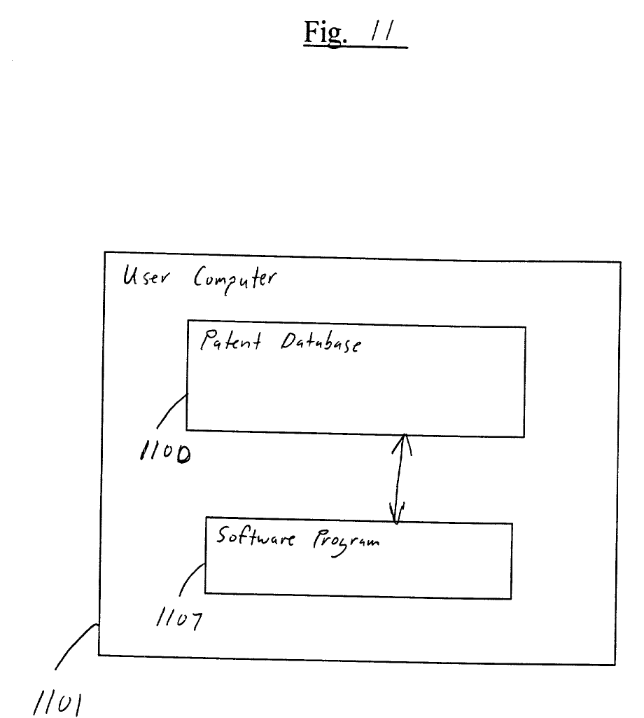

Referring now to FIG. 11, a fifth embodiment of the instant invention is shown. This embodiment relates to searching for references contained within a Patent Database 1100 associated with a User Computer 1101 (as opposed to searching via the Internet as with the previous embodiments). As seen in this FIG. 11, User Computer 1101 (which is shown in block diagram form and which includes a CPU, a monitor, a keyboard, and a mouse, all of which are not shown) has installed thereon Patent Database 1100. Alternatively, Patent Database 1100 may be associated with User Computer 1101 through a local area network, or a wide area network, or by being made available on a CD accessible by User Computer 1101. In any case, such association of a computer with a database is well known to one of ordinary skill in the art and shall not be discussed further. User Computer 1101 also has installed thereon Software Program 1107. Software Program 1107 may be installed on User Computer 1101 using any suitable procedure such as CD distribution or electronic distribution, for example. Such suitable installation procedures are well known to those of ordinary skill in the art and shall not be discussed further.

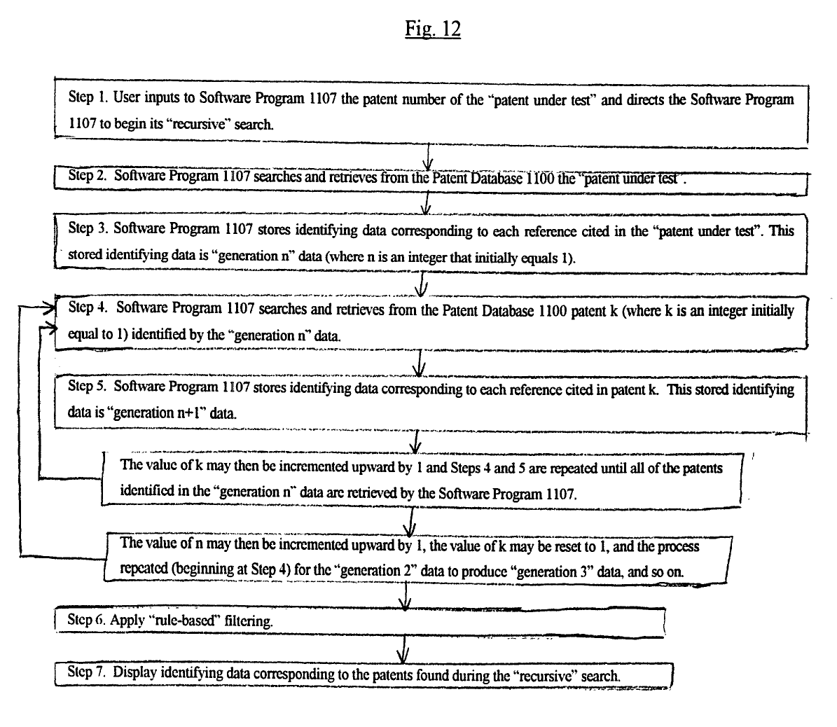

The operation of Software Program 1107 will now be described in more detail with reference to FIG. 12.

As seen in FIG. 12, at Step 1 a user inputs to Software Program 1107 the patent number of the “patent under test” (which may be a potentially infringed patent or a potentially invalid patent, for example) and directs the Software Program 1107 to begin its “recursive” search. At Step 2 the Software Program 1107 searches and retrieves from the Patent Database 1100 the “patent under test”. At Step 3 the Software Program 1107 stores identifying data corresponding to each reference cited in the “patent under test”. The stored identifying data may include the patent number, the issue date, the inventor name, and the class/subclass of each reference. This stored identifying data is “generation n” data (where n is an integer that initially equals 1). At Step 4 the Software Program 1107 searches and retrieves from the Patent Database 1100 patent k (where k is an integer initially equal to 1) identified by the “generation n” data. At Step 5 the Software Program 1107 stores identifying data corresponding to each reference cited in patent k. The stored identifying data may include the patent number, the issue date, the inventor name, and the class/subclass of each reference. This stored identifying data is “generation n+1” data (i.e., if n is currently equal to 1 then this is “generation 2” data, if n is currently equal to 2 then this is “generation 3” data, and so on) . The value of k may then be incremented upward by 1 and Steps 4 and 5 are repeated until all of the patents identified in the “generation n” data are retrieved by the Software Program 1107. The value of n may then be incremented upward by 1, the value of k may be reset to 1, and the process repeated (beginning at Step 4) for the “generation 2” data to produce “generation 3” data, and so on.

The user may indicate to Software Program 1107 to search for a given number of generations of data, or the user may indicate to Software Program 1107 to search for a given length of time, or the user may indicate to Software Program 1107 to search until a given number of references have been stored, or the user may allow the Software Program 1107 to search until commanded to stop by the user.

In any case, after the Software Program 1107 finishes the “recursive” search it may employ “rule-based” filtering (Step 6 of FIG. 12) to narrow the search results. The “rule-based” filtering may be in the form described with reference to the first embodiment of the instant invention.

After the “rule-based” filtering is applied the identifying data corresponding to the patents found during the “recursive” search may be displayed to the user (Step 7 of FIG. 12). The display may be in the form described with reference to the first embodiment of the instant invention. The Software Program 1107 may also provide the user the option of printing out and/or storing the search results.

It is noted that this fifth embodiment was not described as utilizing parsing of the documents retrieved by the Software Program 1107 from the Patent Database 1100. This is because it is presumed that the documents which are retrieved are in binary format in a record structure known to Software Program 1107; thus no “parsing” operation would be necessary. If this is not the case, that is, if the documents are in a text based format, for example, then parsing of the documents in a manner described with reference to the first four embodiments can be applied.

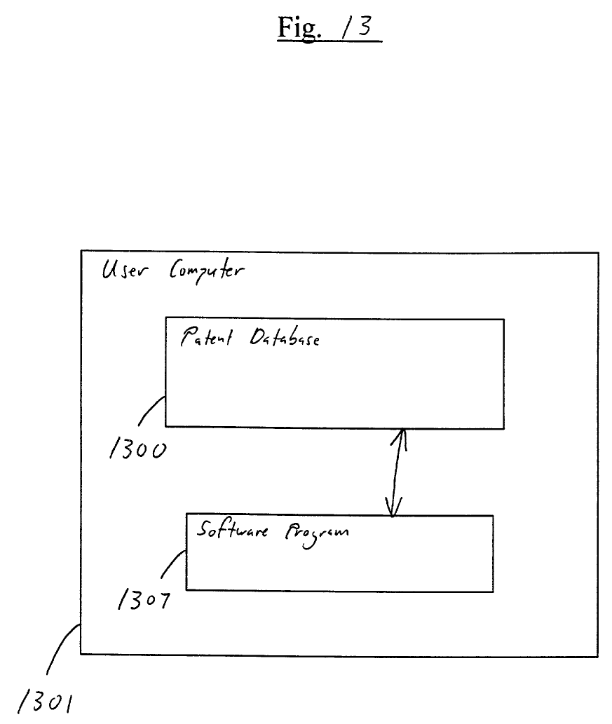

Referring now to FIG. 13, a sixth embodiment of the instant invention is shown. This embodiment, like the fifth embodiment, relates to searching for references contained within a Patent Database 1300 associated with a User Computer 1301 (as opposed to searching via the Internet as with the first four embodiments). The main difference between these two embodiments is that the fifth embodiment performs a “recursive” search initially based upon the references cited in the “patent under test” while the sixth embodiment performs a “recursive” search initially based upon the references citing the “patent under test”. In any case, as seen in this FIG. 13, User Computer 1301 (which is shown in block diagram form and which includes a CPU, a monitor, a keyboard, and a mouse, all of which are not shown) has installed thereon Patent Database 1300. Alternatively, Patent Database 1300 may be associated with User Computer 1301 through a local area network, or a wide area network, or by being made available on a CD accessible by User Computer 1301. Such association of a computer with a database is well known to one of ordinary skill in the art and shall not be discussed further. User Computer 1301 also has installed thereon Software Program 1307. Software Program 1307 may be installed on User Computer 1301 using any suitable procedure such as CD distribution or electronic distribution, for example. Such suitable installation procedures are well known to those of ordinary skill in the art and shall not be discussed further.

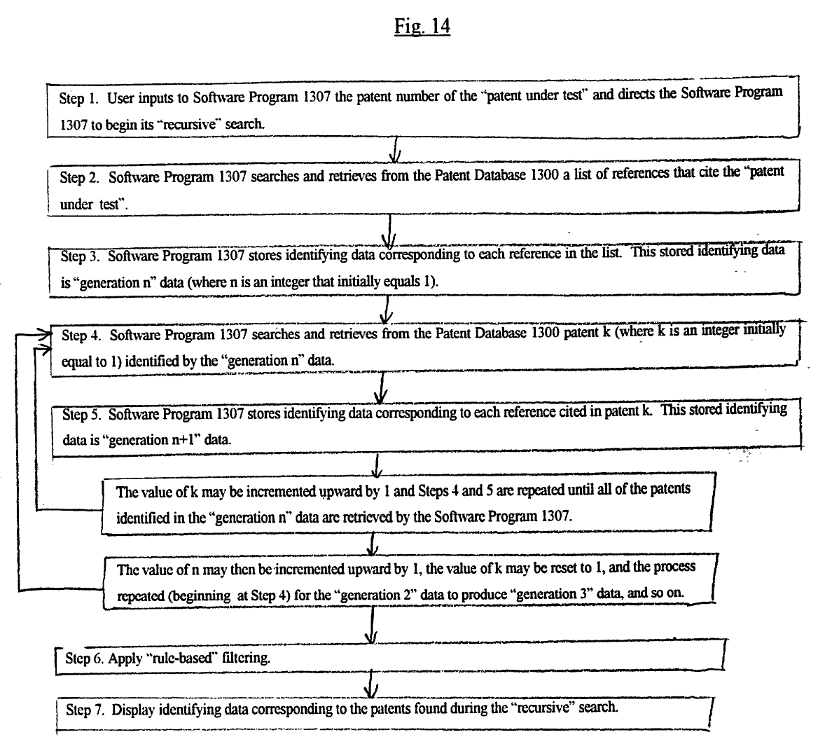

The operation of Software Program 1307 will now be described in more detail with reference to FIG. 14.

As seen in FIG. 14, at Step 1 a user inputs to Software Program 1307 the patent number of the “patent under test” (which may be a potentially infringed patent or a potentially invalid patent, for example) and directs the Software Program 1307 to begin its “recursive” search. At Step 2 the Software Program 1307 searches and retrieves from the Patent Database 1300 a list of references that cite the “patent under test”. At Step 3 the Software Program 1307 stores identifying data corresponding to each reference in the list. The stored identifying data may include the patent number, the issue date, the inventor name, and the class/subclass of each reference. This stored identifying data is “generation n” data (where n is an integer that initially equals 1). At Step 4 the Software Program 1307 searches and retrieves from the Patent Database 1300 patent k (where k is an integer initially equal to 1) identified by the “generation n” data. At Step 5 the Software Program stores identifying data corresponding to each reference cited in patent k. The stored identifying data may include the patent number, the issue date, the inventor name, and the class/subclass of each reference. This stored identifying data is “generation n+1” data (i.e., if n is currently equal to 1 then this is “generation 2” data, if n is currently equal to 2 then this is “generation 3” data, and so on) . The value of k may then be incremented upward by 1 and Steps 4 and 5 are repeated until all of the patents identified in the “generation n” data are retrieved by the Software Program 1307. The value of n may then be incremented upward by 1, the value of k may be reset to 1, and the process repeated (beginning at Step 4) for the “generation 2” data to produce “generation 3” data, and so on.

The user may indicate to Software Program 1307 to search for a given number of generations of data, or the user may indicate to Software Program 1307 to search for a given length of time, or the user may indicate to Software Program 1307 to search until a given number of references have been stored, or the user may allow the Software Program 1307 to search until commanded to stop by the user.

In any case, after the Software Program 1307 finishes the “recursive” search it may employ “rule-based” filtering (Step 6 of FIG. 14) to narrow the search results. The “rule-based” filtering may be in the form described with reference to the first embodiment of the instant invention.

After the “rule-based” filtering is applied the identifying data corresponding to the patents found during the “recursive” search may be displayed to the user (Step 7 of FIG. 14). The display may be in the form described with reference to the first embodiment of the instant invention. The Software Program 1307 may also provide the user the option of printing out and/or storing the search results.

It is noted that this sixth embodiment was not described as utilizing parsing of the documents retrieved by the Software Program 1307 from the Patent Database 1300. This is because it is presumed that the documents which are retrieved are in binary format in a record structure known to Software Program 1307; thus no “parsing” operation would be necessary. If this is not the case, that is, if the documents are in a text based format, for example, then parsing of the documents in a manner described with reference to the first four embodiments can be applied.

While a number of embodiments of the instant invention have been described, it is understood that these embodiments are illustrative only, and not restrictive, and that many modifications may become apparent to those of ordinary skill in the art. For example, the automatic and adaptive “recursive” search of the instant invention may utilize both data related to references cited by the “patent under test” as well as data related to references that cite the “patent under test” in a single “recursive” search (i.e., a combination of the first and second embodiments, or a combination of the third and fourth embodiments, or a combination of the fifth and sixth embodiments, for example). Further, any desired number of “generations” of identifying data corresponding to references cited by the “patent under test” and/or references that cite the “patent under test” may be generated and used during the “recursive” search. Further still, when applying the “rule-based” filtering, instead of marking as less relevant or non-relevant those patents that do not meet the “rules”, the identifying data corresponding to such non-compliant references can simply be deleted. Further still, while the embodiments described herein mentioned the text of 35 USC 102 and 35 USC 103 as “rules” to employ during the “rule-based” filtering any desired laws or regulations may be used (i.e., different or subsequent patent laws or regulations of the United States of America and/or patent laws or regulations of other countries besides the United States of America). Further still, while embodiments one through four were described with reference to the U.S. Patent Office, any other appropriate government or non-government database may be searched (i.e., the Database maintained by the European patent authority or the Database maintained by the Japanese patent authority). Further still, the identifying data corresponding to the references found during the “recursive” search may be stored using volatile or non-volatile means, such as ROM, RAM, or magnetic media, for example. Further still, such identifying data may be stored in any appropriate structure, such as an array of elements or a database. Further still, while the Software Program has been described as a stand-alone program its functions may, of course, be integrated with other software such as a web browser, for example. The integration may take place at the source code level (i.e., the web browser may be originally written to include the functionality of the Software Program described herein) or the integration may take place through any other suitable means, such as the use of a “plug-in” which provides the functionality of the Software Program described herein. Further still, it is noted that some of the operational steps carried out by the instant invention may be carried out in a different order from that described herein to achieve substantially the same result. Further still, while the invention has been described principally with respect to communication via the Internet, local area networks, and wide area networks, other networking methodologies may, of course, be employed (such as intranets and extranets, for example). Further still, while the embodiments described herein indicate that all of the references identified in a given generation of data are retrieved from the database it is noted that if any such references are not available they will simply be passed over during the “recursive” search. Further still, it is noted that the instant invention may include automatic batch processing of multiple “patents under test”. Further still, it is noted with respect to embodiments three and four, which include an Intermediate Server Computer, that the Intermediate Server Software associated therewith can be operated from a Website which provides controlled access (i.e., the features of the Intermediate Server Software may be accessible on a pay-per-use, or on a subscription basis, for example) . Further still, while the invention has been described principally with respect to patent databases, it may, of course, be applied to find references in databases containing other types of documents.

What is claimed is:

1. A method for identifying documents in a database which relate to a document under test, comprising:
retrieving the document under test from the database;
storing as generation 1 data identifying data corresponding to each reference cited in the document under test;
retrieving from the database each available reference identified by the identifying data stored as generation 1 data; and
storing as generation 2 data identifying data corresponding to each reference cited in the references identified by the generation 1 data.

2. The method of claim 1, further comprising receiving from a user an identification of the document under test.

3. The method of claim 1, further comprising applying rule-based filtering to the stored identifying data.

4. The method of claim 1, further comprising displaying the stored identifying data to the user.

5. The method of claim 1, wherein the document under test is a patent.

6. A method for identifying documents in a database which relate to a document under test, comprising:
retrieving from the database a list of documents that cite the document under test;
storing as generation 1 data identifying data corresponding to each reference in the list;
retrieving from the database each available reference identified by the identifying data stored as generation 1 data; and
storing as generation 2 data identifying data corresponding to each reference cited in the references identified by the generation 1 data.

7. The method of claim 6, further comprising receiving from a user an identification of the document under test.

8. The method of claim 6, further comprising applying rule-based filtering to the stored identifying data.

9. The method of claim 6, further comprising displaying the stored identifying data to the user.

10. The method of claim 6, wherein the document under test is a patent.

11. A method for identifying documents in a database which relate to a document under test, comprising:
retrieving from the database a list of documents that cite the document under test;
storing as generation 1 data identifying data corresponding to each document in the list;
retrieving from the database a list of documents that cite each document identified by the identifying data stored as generation 1 data; and
storing as generation 2 data identifying data corresponding to each document in the list of documents that cite each document identified in the generation 1 data.

12. The method of claim 11, further comprising receiving from a user an identification of the document under test.

13. The method of claim 11, further comprising applying rule-based filtering to the stored identifying data.

14. The method of claim 11, further comprising displaying the stored identifying data to the user.

15. The method of claim 11, wherein the document under test is a patent.
